(19) United States
(12) Patent Application Publication
(10) Pub. No.: US 2007/0195709 A1
(43) Pub. Date: Aug. 23, 2007

(54) Methods and Systems for Notifying and Negotiating Capabilities of Monitoring the Performance of Label Switching Path

(75) Inventor: Jianfei He, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., Ltd., Shenzhen (CN)

(21) Appl. No.: 11/688,581

(22) Filed: Mar. 20, 2007

Related U.S. Application Data
(63) Continuation of application No. PCT/CN06/00559, filed on Mar. 30, 2005.

(30) Foreign Application Priority Data
Mar. 30, 2005 (CN) 200510058847.6

(51) Int. Cl. H04J 1/16; H04L 12/26

(52) U.S. Cl. 370/252; 370/392

(57) ABSTRACT

A method and system for notifying capabilities of monitoring performance of Label Switching Path (LSP), and the method includes: a source node sends to a destination node a request message for establishing an LSP, carrying the capabilities of monitoring performance of LSP provided by the source node; after receiving the request message, the destination node returns a response message carrying capabilities of monitoring performance of LSP provided by the destination node to the source node. A method and system for negotiating capabilities of monitoring performance of LSP are disclosed by embodiments of the present invention.

This application is a continuation of International Patent Application No. PCT/CN2006/000559, filed Mar. 30, 2006, which claims priority to Chinese Patent Application No. 200510058847.6, filed Mar. 30, 2005, all of which are hereby incorporated by reference.

### FIELD OF THE INVENTION

The present invention relates to a technique of label switching, and in particular, to methods and systems for notifying and negotiating capabilities of monitoring performance of label switching path (LSP) implemented in a label switching network.

### BACKGROUND OF THE INVENTION

As a key technique of Next Generation Network (NGN), Multi-Protocol Label Switching (MPLS) technique plays an increasingly important role in IP network. Originally the MPLS technique is provided for enhancing a forwarding speed of a router. Due to advantages of the MPLS technique per se, it has also seen wide application in traffic engineering (TE), Virtual Private Network (VPN) and Quality of Service (QoS), and has become an important standard of the large-scale Internet Protocol (IP) network.

With further modifications, the MPLS technique has gradually evolved into a General MPLS (GMPLS) technique. Currently, the GMPLS technique can be used in a packet switching network such as an Ethernet. The packet switching network can be generally referred to as a label switching network.

At present, a function of monitoring the label switching performance of LSP in a label switching network has to be implemented with hardware or firmware, for example, the function of monitoring label switching performance can be implemented on the source node and the destination node of the LSP via detecting the Fast Failure Detection (FFD) frame by the hardware. In this specification, the performance of LSP generally refers to the label switching performance of the LSP. As the fastest FFD can only send a frame per 10 ms and there may be many LSPs to be monitored, thus in view of the balance of network resources, functions and different requirements of monitoring label switching performance of different service levels, the hardware resources of label switching network can not support to monitor label switching performance of all LSPs. Therefore, along with gradual increase of the application of communication level service, it has become an important issue to meet different requirements of monitoring the label switching performance of different LSPs.

### SUMMARY OF THE INVENTION

Embodiments of the present invention provide methods and systems for notifying and negotiating capabilities of monitoring performance of LSP.

A method for notifying capabilities of monitoring performance of LSP includes the following steps:

a source node sends a request message for establishing an LSP, carrying capabilities of monitoring performance of LSP provided by the source node, to a destination node;

upon receiving the request message, the destination node returns a response message carrying capabilities of monitoring performance of LSP provided by the destination node to the source node.

A method for negotiating capabilities of monitoring performance of LSP includes the following steps:

a source node sends a request message for establishing an LSP, carrying capabilities of monitoring performance of LSP provided by the source node, to a destination node;

the destination node matches the capabilities of monitoring performance of LSP provided by the source node with capabilities of monitoring performance of LSP provided by the destination node, and returns a response message carrying the matched capabilities of monitoring performance of LSP to the source node.

A system for notifying capabilities of monitoring performance of LSP includes a source node, configured to send a request message for establishing an LSP, carrying capabilities of monitoring performance of LSP provided by the source node; a destination node, configured to carry capabilities of monitoring performance of LSP provided by the destination node in a response message returned to the source node upon receiving the request message.

A system for negotiating capabilities of monitoring performance of LSP includes: a source node, configured to send a request message for establishing an LSP, carrying capabilities of monitoring performance of LSP provided by the source node; a destination node, configured to match the capabilities of monitoring performance of LSP provided by the source node with capabilities of monitoring performance of LSP provided by the destination node, and carry the matched capabilities of monitoring performance of LSP in a response message returned to the source node.

### BRIEF DESCRIPTION OF THE DRAWINGS

FIG. 1 is a schematic diagram of an LSP established between nodes of a label switching network.

FIG. 2 is a flow chart illustrating the process of notifying capabilities of monitoring performance of LSP in accordance with an embodiment of the present invention when an LSP is established via the Resource Reservation Protocol (RSVP).

FIG. 3 is a flow chart illustrating the process of negotiating capabilities of monitoring performance of LSP in accordance with an embodiment of the present invention when an LSP is established via the RSVP.

FIG. 4 is a flow chart illustrating the process of notifying capabilities of monitoring performance of LSP in accordance with an embodiment of the present invention when an LSP is established via the Label Distribute Protocol (LDP) or (Constraint Route LDP (CR-LDP).

FIG. 5 is a schematic diagram illustrating a code of label request message with the extended LDP in accordance with an embodiment of the present invention.

FIG. 6 is a schematic diagram illustrating the code of label mapping message with the extended LDP in accordance with an embodiment of the present invention.

FIG. 7 is a flow chart illustrating the process of negotiating capabilities of monitoring performance of LSP when an LSP is established via the LDP or CR-LDP in accordance with an embodiment of the present invention.

### EMBODIMENTS OF THE INVENTION

It is seen from the above, in the method for notifying capabilities of monitoring performance of LSP, the capabilities information of monitoring performance of LSP is carried in the process of establishing an LSP by a signaling message, which makes it possible that the source node and the destination node of the established LSP notify their own capabilities of monitoring performance of LSP to each other, so as to solve the problem that it is impossible to meet all requirements of monitoring performance of LSP when the label switching performance is monitored by the limited hardware or firmware resources in the related art.

In addition, in the method for negotiating capabilities of monitoring performance of LSP, the capabilities information of monitoring performance of LSP is carried in the process of establishing an LSP by a signaling message; the capabilities of monitoring performance of LSP are negotiated between the source node and the destination node of the established LSP according to the capabilities and resources of the destination node, which do not depend on the hardware and firmware of the label switching network, thereby meeting the different performance monitoring requirements. At the same time, resources of label switching network can be allocated to the LSP of which the performance needs to be monitored via the negotiation of capabilities of monitoring performance of LSP.

In order to meet the different requirements of monitoring label switching performance of different LSPs, in the embodiment of the present invention, information of capabilities of monitoring performance of LSP is carried by a signaling message in the process of establishing an LSP, which makes it possible that the source node and the destination node of the established LSP notify or negotiate their own capabilities of monitoring performance of LSP with each other.

The described capabilities of monitoring the label switching performance of the LSP also include, the capabilities of monitoring packet-loss rate, delay, and delay jittering.

An LSP can be established through the RSVP, the LDP or the CR-LDP.

The methods for notifying and negotiating capabilities of monitoring the performance of the LSP mentioned in the embodiment of the present invention are hereinafter described in detail in accordance with embodiments of the present invention.

### A FIRST EMBODIMENT

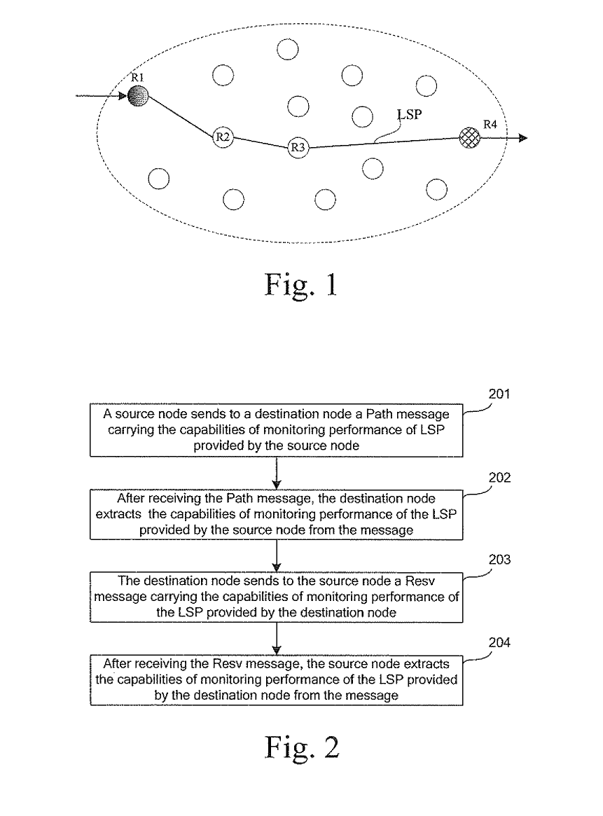

A method for notifying capabilities of monitoring performance of LSP between a source node and a destination node of an LSP is described in this embodiment by taking the process of establishing an LSP using the RSVP between Node R1 and Node R4 shown in FIG. 1 as an example.

In this embodiment, the LSP that will be established is R1->R2->R3->R4. Node R1 is a source node and Node R4 is a destination node. The method for notifying capabilities of monitoring performance of LSP between source node R1 and destination node R4 is as shown in FIG. 2, which includes the following steps.

Step 201, source node R1 sends to destination node R4 a Path message requesting for establishing an LSP, and the Path message carries the capabilities of monitoring the performance of the LSP provided by source node R1.

In this case, the capabilities of monitoring performance of LSP provided by source node R1 should be determined according to the capabilities of monitoring performance of LSP required by the LSP besides according to the resource and the capabilities of monitoring performance of LSP of source node R1. For example, if the LSP requires two kinds of capabilities of monitoring performance of LSP i.e. the capability of monitoring the packet-loss rate performance and the capability of monitoring the delay performance, and source node R1 can provide the two kinds of capabilities of monitoring performance of LSP, then source node R1 will carry the two kinds of capabilities of monitoring performance of LSP in the Path message.

As the existing RSVP does not support the notification of the above two kinds of capabilities of monitoring performance of the LSP, the existing Path message can not carry the above two kinds of capabilities of monitoring performance of LSP; therefore, it is needed to extend the existing RSVP in this embodiment.

According to the embodiment of the method, the RSVP is extended by adding a perMonitor Object carrying a performance monitoring field. The performance monitoring field can carry one or more kinds of capabilities of monitoring performance of LSP which are respectively indicated by fixed-number bits, for example, with 4 bits, up to 16 kinds of capabilities of monitoring performance of LSP can be indicated.

After the perfMonitor Object is added to the RSVP, source node R1 can carry the capabilities of monitoring performance of the LSP provided by source node R1 via the Path message carrying the perfMonitor Object to destination node R4 of the LSP. The format of Path message carrying the perfMonitor Object is as follows.

<Path Message>::=<Common Header> [<INTEGRITY>]

<SESSION> <RSVP_HOP>

<TIME_VALUES>

[<POLICY_DATA>...]

[<sender descriptor>]

<sender descriptor>::=<SENDER_TEMPLATE>

<SENDER_TSPEC><perfMonitor Object>

[<ADSPEC>]

Step 202, after receiving the Path Message, destination node R4 extracts the capabilities of monitoring performance of the LSP provided by source node R1 from the message.

As the capabilities of monitoring performance of LSP provided by source node R1 is carried in the perfMonitor Object of Path message, destination node R4 can extract the capabilities of monitoring performance of LSP from the perMonitor Object of the Path message.

Destination node R4 can learn the capabilities of monitoring performance of LSP provided by source node R1 via the above Steps 201 and 202.

Step 203, destination node R4 sends to source node R1 a Resv message carrying the capabilities of monitoring performance of LSP provided by destination node R4.

Likewise, destination node R4 can send to source node R1 of the LSP the capabilities of monitoring performance of LSP provided by destination node R4 via the Resv message which carries the perfMonitor Object. The format of Resv message carrying the perfMonitor Object is as follows.

<Resv Message>::=<Common Header> [<INTEGRITY>]

<SESSION> <RSVP_HOP>

<TIME_VALUES>

[<RESV_CONFIRM>] [<SCOPE>]

[<POLICY_DATA>...]

<STYLE> <flow descriptor list>

<flow descriptor list>::=<empty> |

<flow descriptor list> <flow descriptor><perfMonitor Object>

Step 204, after receiving the Resv message, source node R1 extracts from the message the capabilities of monitoring performance of the LSP provided by destination node R4 carried in the perfMonitor Object.

Source node R1 can learn the capabilities of monitoring performance of LSP provided by destination node R4 via the above Steps 203 and 204.

Up to now, an LSP is established and the notification of capabilities of monitoring performance of the LSP is implemented between source node R1 and destination node R4 of the established LSP.

### A SECOND EMBODIMENT

A method for negotiating capabilities of monitoring performance of LSP between the source node and the destination node of an LSP is described by the process of establishing an LSP through the RSVP between the Node R1 and the Node R4 shown in FIG. 1.

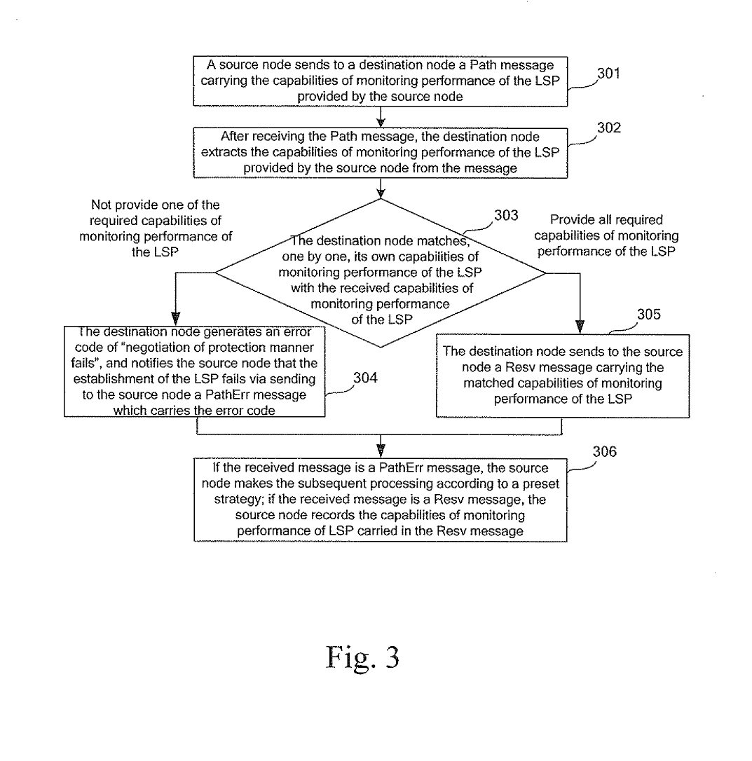

In this embodiment, the LSP that will be established is R1->R2->R3->R4. Node R1 is a source node and Node R4 is a destination node. The method for negotiating capabilities of monitoring performance of LSP between source node R1 and destination node R4 is as shown in FIG. 3, which includes the following steps.

Step 301, source node R1 sends to destination node R4 a Path message requesting for establishing an LSP, and the Path message carries the capabilities of monitoring performance of LSP provided by source node R1 and a requirement degree identifier for each capability of monitoring performance of LSP, for example, whether such a capability of monitoring performance of LSP is required or optional.

In this case, the capabilities of monitoring performance of LSP provided by source node R1 should be determined according to the capabilities of monitoring performance of LSP required by the LSP besides according to the resource and capabilities of monitoring performance of LSP of source node R1. For example, if the LSP requires two kinds of capabilities of monitoring performance of LSP i.e. monitoring the packet-loss rate performance and monitoring the delay performance, and source node R1 can provide the two kinds of capabilities of monitoring performance of LSP, source node R1 deems that the capabilities of monitoring packet-loss rate performance is required and the capabilities of monitoring delay performance is optional. Then source node R1 will carry the two kinds of capabilities of monitoring performance of LSP i.e. the capability of monitoring packet-loss rate performance and the capability of monitoring delay performance in the Path message, and indicates that the capability of monitoring packet-loss rate performance is required while the capability of monitoring delay performance is optional.

In order to implement the negotiation of capabilities of monitoring performance of LSP, it is needed to extend the existing RSVP in this embodiment. According to the embodiment of the method, the RSVP is extended by adding a perMonitor Object carrying a performance monitoring field. The performance monitoring field can carry one or more kinds of capabilities of monitoring performance of LSP which are respectively indicated by fixed-number bits. In addition, it is required to indicate, by using fixed-number bits, whether each kind of capabilities of monitoring performance of LSP is required or optional in the performance monitoring field. If the destination node can not support the required capabilities of monitoring performance of LSP, the establishment of LSP fails; if the destination node can not support the optional capabilities of monitoring performance of LSP, the establishment of LSP is still allowed.

In this step, the format of Path message sent by source node R1 is the same as that described in the first embodiment.

Step 302, after receiving the Path message, destination node R4 extracts the capabilities of monitoring performance of the LSP provided by source node R1 from the message.

Similar to Step 202, destination node R4 can extract the capabilities of monitoring performance of the LSP from the perfMonitor Object of the received Path message.

Destination node R4 can learn the capabilities of monitoring performance of the LSP provided by source node R1 and the different requirement for each capability of monitoring performance of the LSP via the above Step 301 and Step 302.

Step 303, destination node R4 matches, one by one, its own resources and capabilities of monitoring performance of the LSP with the capabilities of monitoring performance of the LSP that are required by the LSP and that can be provided by source node R1 carried in the Path message. If destination node R4 can not provide one of the required capabilities of monitoring performance of LSP, proceed to Step 304; otherwise proceed to Step 305.

Step 304, destination node R4 generates an error code of “negotiation of protection manner fails”, and notifies the source node that the establishment of LSP fails via sending to the source node a PathErr message which carries the error code, and proceed to Step 306.

As the existing RSVP does not define an error code indicating that the negotiation of protection manner fails, it is needed to extend the RSVP to implement the above Step 304. The detailed process includes: extending an Error Code field and an Error Value field of an existing ERROR_SPEC object, adding a code and an error value indicating that the negotiation of protection manner fails, and carrying the extended ERROR_SPEC object in the PathErr message to notify source node R1 of LSP that the negotiation of protection manner fails.

Step 305, destination node R4 sends to source node R1 a Resv message carrying the matched capabilities of monitoring performance of LSP, and proceed to Step 306.

The format of Resv message sent in this step is the same as that described in the first embodiment. The capabilities of monitoring performance of the LSP provided by destination node R4, matching the capabilities of monitoring performance of LSP, are carried in the perfMonitor Object carried in the extended Resv message.

Step 306, when source node R1 receives the message returned from destination node R4, if the received message is a PathErr message carrying an error code which indicates that the negotiation of protection manner fails, source node R1 makes the subsequent processing according to a preset strategy, for example, it may initiate a negotiation of capabilities of monitoring performance of LSP again by lowering the requirement of capabilities of monitoring performance of LSP, or terminate the process of establishing the LSP; if the received message is a Resv message carrying the matched capabilities of monitoring performance of LSP, source node R1 learns the capabilities of monitoring performance of LSP that can be supported by destination node R4 via recording the capabilities of monitoring performance of the LSP in the performance monitoring field carried in the perMonitor Object of the Resv message.

Up to now, an LSP is established and the negotiation of capabilities of monitoring performance of LSP is implemented between source node R1 and destination node R4 of the established LSP.

### A THIRD EMBODIMENT

A method for notifying capabilities of monitoring performance of LSP between a source node and a destination node of an LSP is described in this embodiment by taking the process of establishing the LSP through the LDP or CR-LDP between Node R1 and Node R4 shown in FIG. 1 as an example.

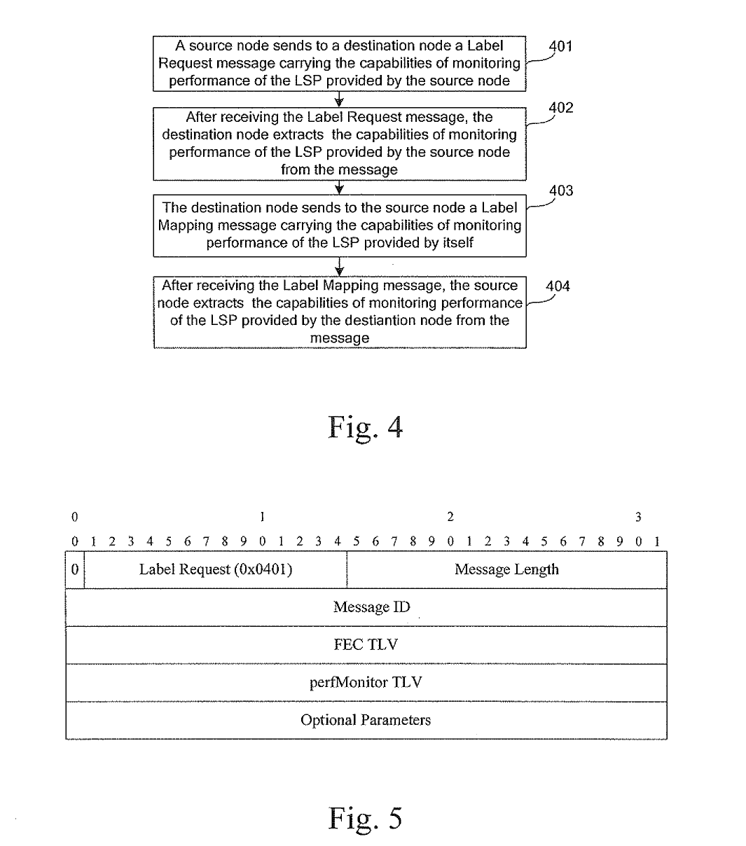

In this embodiment, the LSP that will be established is R1->R2->R3->R4. Node R1 is a source node and Node R4 is a destination node. The method for notifying capabilities of monitoring performance of LSP between source node R1 and destination node R4 is as shown in FIG. 4, which includes the following steps.

Step 401, source node R1 sends to destination node R4 a Label Request message requesting for establishing an LSP, and the Label Request message carries the capabilities of monitoring performance of the LSP that can be provided by source node R1.

In this case, the capabilities of monitoring performance of LSP provided by source node R1 should be determined according to the capabilities of monitoring performance of LSP required by the LSP besides according to the resources and capabilities of monitoring performance of LSP of source node R1.

As the existing LDP or CR-LDP does not support the above notification of capabilities of monitoring performance of LSP, the existing Label Request message can not carry the capabilities of monitoring performance of LSP provided by source node R1; therefore, it is needed to extend the existing LDP or CR-LDP.

According to the main method, the LDP or CR-LDP is extended to incorporate a perfMonitor TLV carrying a performance monitoring field. The performance monitoring field can carry several kinds of capabilities of monitoring performance of LSP which are respectively indicated by fixed-number bits.

After the perfMonitor Object is incorporated in the LDP or CR-LDP, source node R1 can send to destination node R4 the capabilities of monitoring performance of the LSP provided by source node R1 via the Label Request message carrying the perfMonitor TLV. It is needed to add a perfMonitor TLV to the Label Request message to achieve the above objective, and the format of an extended Label Request message is as shown in FIG. 5.

Step 402, after receiving the Label Request message, destination node R4 extracts the capabilities of monitoring performance of LSP provided by source node R1 from the message.

As the capabilities of monitoring performance of the LSP provided by source node R1 is carried in the perfMonitor TLV of Label Request message, destination node R4 can extract the capabilities of monitoring performance of LSP from the perfMonitor TLV carried by the received Label Request message.

Destination node R4 can learn the capabilities of monitoring performance of LSP provided by source node R1 of LSP via the above Step 401 and Step 402.

Step 403, destination node R4 sends to source node R1 a Label Mapping message carrying the capabilities of monitoring performance of LSP provided by destination node R4.

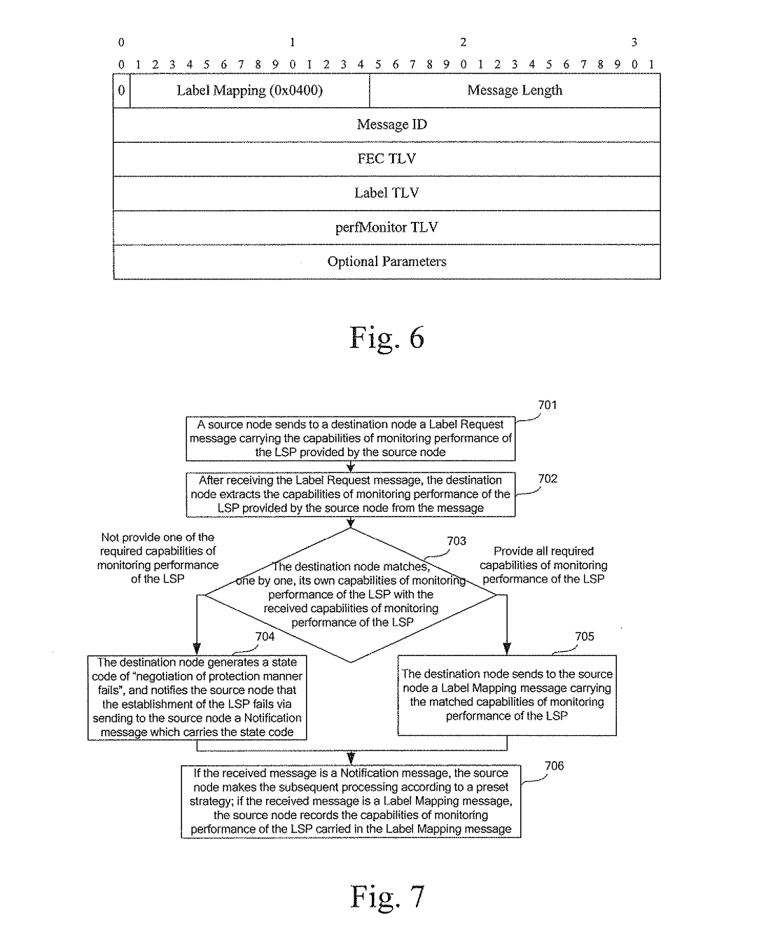

Likewise, the capabilities of monitoring performance of the LSP provided by destination node R4 are also carried in a perfMonitor TLV, and it is needed to add a perfMonitor TLV to the Label Mapping message. The format of extended Label Mapping message is as shown in FIG. 6.

Step 404, after receiving the Label Mapping message, source node R1 extracts the perfMonitor TLV from the message and learns the capabilities of monitoring performance of LSP provided by destination node R4.

Source node R1 can learn the capabilities of monitoring performance of the LSP provided by destination node R4 via the above Step 403 and Step 404.

Up to now, an LSP is established and the notification of capabilities of monitoring performance of LSP is implemented between source node R1 and destination node R4 of the established LSP.

### A FORTH EMBODIMENT

A method for negotiating capabilities of monitoring performance of LSP between the source node and the destination node of an LSP is described in this embodiment by taking the process of establishing an LSP through the LDP or CR-LDP between the Node R1 and the Node R4 shown in FIG. 1 as an example.

In this embodiment, the LSP that will be established is R1->R2->R3->R4. Node R1 is a source node and Node R4 is a destination node. The method for negotiating capabilities of monitoring performance of LSP between source node R1 and destination node R4 is as shown in FIG. 7, which includes the following steps.

Step 701, source node R1 sends to destination node R4 a Label Request message requesting for establishing an LSP, and the Label Request message carries the capabilities of monitoring performance of the LSP provided by source node R1 and a requirement degree identifier for each kind of capabilities of monitoring performance of the LSP, for example, whether the capability of monitoring performance of LSP is required or optional.

In this case, the capabilities of monitoring performance of LSP provided by source node R1 should be determined according to the capabilities of monitoring performance of LSP required by the LSP besides according to the resource and capabilities of monitoring performance of LSP of source node R1.

In order to implement the negotiation of capabilities of monitoring performance of the LSP, it is needed to extend the existing LDP or CR-LDP in this embodiment. According to the main method, the LDP or CR-LDP is also extended to incorporate a perfMonitor TLV carrying a performance monitoring field. The performance monitoring field can carry one or more kinds of capabilities of monitoring performance of LSP which are respectively indicated by fixed-number bits. In addition, in the performance monitoring field by using fixed-number bits, it is needed to indicate whether each kind of capabilities of monitoring performance of LSP is required or optional. If the destination node can not support a required capability of monitoring performance of LSP, the establishment of LSP fails; if the destination node can not support an optional capability of monitoring performance of LSP, the establishment of LSP is still allowed.

In this step, the format of Label Request message sent by source node R1 is the same as that described in FIG. 5.

Step 702, after receiving the Label Request message, destination node R4 extracts the capabilities of monitoring performance of LSP provided by source node R1 from the message.

Similar to Step 402, destination node R4 can extract the capabilities of monitoring performance of LSP from the perfMonitor TLV of the Label Request message.

Destination node R4 can learn the capabilities of monitoring performance of the LSP provided by source node R1 and the different requirement for each kind of capabilities of monitoring performance of the LSP via the above Step 701 and Step 702.

Step 703, destination node R4 matches, one by one, its own resource and capabilities of monitoring performance of the LSP with the capabilities of monitoring performance of the LSP that is required by the LSP and that can be provided by source node R1 carried in the Label Request message. If destination node R4 can not provide one kind of the required capabilities of monitoring performance of the LSP, proceed to Step 704; otherwise proceed to Step 705.

Step 704, destination node R4 generates a state code of “negotiation of protection manner fails”, and notifies source node R1 that the establishment of LSP fails via sending to the source node a Notification message carrying the state code, proceed to Step 706.

As the existing LDP or CR-LDP does not define a state code indicating that the negotiation of protection manner fails, it is needed to extend the LDP or CR-LDP to implement the above Step 704. The detailed process includes: extending such field as the State Code of the existing Status TLV, adding a state code indicating that the negotiation of protection manner fails, and carrying the extended Status TLV in the Notification message to notify source node R1 of LSP that the negotiation of protection manner fails.

Step 705, destination node R4 sends to source node R1 a Label Mapping message carrying the matched capabilities of monitoring performance of LSP, proceed to Step 706.

The format of Label Mapping message sent in this step is the same as that described in FIG. 6. The capabilities of monitoring performance of the LSP provided by destination node R4, matching the capabilities of monitoring performance of LSP, are carried in the perfMonitor TLV carried in the extended Label Mapping message.

Step 706, when source node R1 receives the message returned from destination node R4, if the received message is a Notification message carrying the state code of “negotiation of protection manner fails”, source node R1 makes the subsequent processing according to a preset strategy, for examples it may initiate a negotiation of capabilities of monitoring performance of LSP again by lowering the requirement of capabilities of monitoring performance of LSP, or terminate the process of establishing the LSP; if the received message is a Label Mapping message carrying the matched capabilities of monitoring performance of LSP, the capabilities of monitoring performance of LSP of the performance monitoring field carried in the perfMonitor TLV of the Label Mapping message are recorded, and source node R1 learns the capabilities of monitoring performance of LSP that supported by destination node R4.

Up to now, an LSP is established and the negotiation of capabilities of monitoring performance of LSP is implemented between source node R1 and destination node R4 of the established LSP.

Obviously, those skilled in the art may make numerous changes and variations on the method for this invention without departing from the spirit and scope thereof. Accordingly, it is intended that this invention includes the changes and variations in case that such changes and variations come within the scope as set forth in the appended claims and the equivalent techniques thereof.

What is claimed is:

1. A method for notifying capabilities of monitoring performance of Label Switching Path (LSP), comprising:
sending, by a source node, a request message for establishing an LSP, carrying capabilities of monitoring performance of LSP provided by the source node, to a destination node; and
upon receiving the request message, returning, by the destination node, a response message carrying capabilities of monitoring performance of LSP provided by the destination node to the source node.

2. The method of claim 1, wherein:
the LSP is established through the Resource Reservation Protocol (RSVP);
the request message comprises a Path message;
the response message comprises a Resv message.

3. The method of claim 2, further comprising: extending a perfMonitor Object containing a performance monitoring field in the RSVP;
wherein the source node carries the capabilities of monitoring performance of LSP provided by the source node in the performance monitoring field of perfMonitor Object, and sends to the destination node the capabilities of monitoring performance of LSP through the Path message carrying the perfMonitor Object; and
the destination node carries the capabilities of monitoring performance of LSP provided by the destination node in the performance monitoring field of perfMonitor Object, and sends to the source node the capabilities of monitoring performance of LSP through the Resv message carrying the perfMonitor Object.

4. The method of claim 1, wherein:
the LSP is established through the Label Distribute Protocol (LDP) or Constraint Route LDP (CR-LDP);
the request message comprises a Label Request message;
the response message comprises a Label Mapping message.

5. The method of claim 4, further comprising: extending a perfMonitor type-length-value (TLV) containing a performance monitoring field in the LDP or CR-LDP;
wherein the source node carries the capabilities of monitoring performance of LSP provided by the source node in the performance monitoring field of perfMonitor TLV, and sends to the destination node the capabilities of monitoring performance of LSP through the Label Request message carrying the perfMonitor TLV; and
the destination node carries the capabilities of monitoring performance of LSP provided by the destination node in the performance monitoring field of perfMonitor TLV, and sends to the source node the capabilities of monitoring performance of LSP through the Label Mapping message carrying the perfMonitor TLV.

6. A method for negotiating capabilities of monitoring performance of Label Switching Path (LSP), comprising;
sending, by a source node, a request message for establishing an LSP, carrying capabilities of monitoring performance of LSP provided by the source node, to a destination node; and
matching, by the destination node, the capabilities of monitoring performance of LSP provided by the source node with capabilities of monitoring performance of LSP provided by the destination node, and returning a response message carrying the matched capabilities of monitoring performance of LSP to the source node.

7. The method of claim 6, further comprising:
carrying, by the source node, a requirement degree identifier corresponding to each kind of capabilities of monitoring performance of LSP in the request message;
wherein in the process of matching the capabilities of monitoring performance of LSP by the destination node, if the destination node does not provide the required capabilities of monitoring performance of LSP indicated by the requirement degree identifier, the destination node sends to the source node a negotiation failure message of capabilities of monitoring performance of LSP.

8. The method of claim 7, further comprising:
upon receiving the negotiation failure message of capabilities of monitoring performance of LSP, lowering by the source node requirements of capabilities of monitoring performance of LSP and initiating a negotiation of capabilities of monitoring performance of LSP.

9. The method of claim 7, further comprising:
upon receiving the negotiation failure message of capabilities of monitoring performance of LSP, terminating by the source node current negotiation of capabilities of monitoring performance of LSP.

10. The method of claim 7, wherein:
the LSP is established through the Resource Reservation Protocol (RSVP);
the request message comprises a Path message;
the response message comprises a Resv message;
the negotiation failure message of capabilities of monitoring performance of LSP comprises a Patherr message.

11. The method of claim 10, further comprising: in the RSVP, extending a perfMonitor Object containing a performance monitoring field;
wherein the source node carries the capabilities of monitoring performance of LSP provided by the source node in the performance monitoring field of perfMonitor Object, and sends to the destination node the capabilities of monitoring performance of LSP through the Path message carrying the perfMonitor Object; and
the destination node carries the capabilities of monitoring performance of LSP provided by the destination node in the performance monitoring field of perfMonitor Object, and sends to the source node the capabilities of monitoring performance of LSP through the Resv message carrying the perfMonitor Object.

12. The method of claim 10, further comprising: adding an error code and an error value, indicating that the negotiation of protection manner fails, to an error code field and an error value field to extend an error description object;
wherein when the destination node does not provide the required capabilities of monitoring performance of LSP, the destination node sends a PathErr message carrying the error description object extended to the source node to notify the source node that the negotiation of capabilities of monitoring performance of LSP fails.

13. The method of claim 7, wherein:
the LSP is established through a Label Distribute Protocol (LDP) or a Constraint Route LDP (CR-LDP);
the request message comprises a Label Request message;
the response message comprises a Label Mapping message;
the negotiation failure message of capabilities of monitoring performance of LSP comprises a Notification message.

14. The method of claim 13, further comprising: extending a perfMonitor type-length-value (TLV) containing a performance monitoring field in the LDP or CR-LDP;
wherein the source node carries the capabilities of monitoring performance of LSP provided by the source node in the performance monitoring field of perfMonitor TLV, and sends to the destination node the capabilities of monitoring performance of LSP provided by the source node through the Label Request message carrying the perfMonitor TLV; and
the destination node carries the capabilities of monitoring performance of LSP provided by the destination node in the performance monitoring field of perfMonitor TLV, and sends to the source node the capabilities of monitoring performance of LSP provided by the destination node through the Label Mapping message carrying the perfMonitor TLV.

15. The method of claim 13, further comprising: adding a state code, indicating that the negotiation of protection manner fails, to a state code field to extend the state code field of the existing state TLV;
wherein when the destination node does not provide the required capabilities of monitoring performance of LSP, the destination node sends a Notification message carrying the state TLV to notify the source node that the negotiation of capabilities of monitoring performance of LSP fails.

16. A system for notifying capabilities of monitoring performance of Label Switching Path (LSP), comprising:
a source node, configured to send a request message for establishing an LSP, carrying capabilities of monitoring performance of LSP provided by the source node;
a destination node, configured to carry capabilities of monitoring performance of LSP provided by the destination node in a response message returned to the source node upon receiving the request message.

17. The system of claim 16, wherein:
the Resource Reservation Protocol (RSVP) is used to establish the LSP, and the RSVP is extended to have a perfMonitor Object containing a performance monitoring field;
the source node is configured to carry the capabilities of monitoring performance of LSP provided by the source node in the performance monitoring field of perfMonitor Object, and send to the destination node the capabilities of monitoring performance of LSP through a Path message carrying the perfMonitor Object; and
the destination node is configured to carry the capabilities of monitoring performance of LSP provided by the destination node in the performance monitoring field of perfMonitor Object, and send to the source node the capabilities of monitoring performance of LSP through a Resv message carrying the perfMonitor Object.

18. The system of claim 16, wherein:
the Label Distribute Protocol (LDP) or Constraint Route LDP (CR-LDP) is used to establish the LSP, and the LDP or the CR-LDP is extended to have a perfMonitor type-length-value (TLV) containing a performance monitoring field;
the source node is configured to carry the capabilities of monitoring performance of LSP provided by the source node in the performance monitoring field of perfMonitor TLV, and send to the destination node the capabilities of monitoring performance of LSP through a Label Request message carrying the perfMonitor TLV; and
the destination node is configured to carry the capabilities of monitoring performance of LSP provided by the destination node in the performance monitoring field of perfMonitor TLV, and send to the source node the capabilities of monitoring performance of LSP through a Label Mapping message carrying the perfMonitor TLV.

19. A system for negotiating capabilities of monitoring performance of Label Switching Path (LSP), comprising:
a source node configured to send a request message for establishing an LSP, carrying capabilities of monitoring performance of LSP provided by the source node;
a destination node, configured to match the capabilities of monitoring performance of LSP provided by the source node with capabilities of monitoring performance of LSP provided by the destination node, and carry the matched capabilities of monitoring performance of LSP in a response message returned to the source node.

20. The system of claim 19, wherein:
the source node is further configured to carry a requirement degree identifier corresponding to each kind of capabilities of monitoring performance of LSP in the request message;
if the destination node does not provide the required capabilities of monitoring performance of LSP indicated by the requirement degree identifier, the destination node is configured to send to the source node a negotiation failure message of capabilities of monitoring performance of LSP; and
the source node is further configured to lower requirements of capabilities of monitoring performance of LSP and initiate a negotiation of capabilities of monitoring performance of LSP upon receiving the negotiation failure message of capabilities of monitoring performance of LSP.

21. The system of claim 19, wherein:
the LSP is established through the Resource Reservation Protocol (RSVP), and the RSVP is extended to have a perfMonitor Object containing a performance monitoring field;
the source node is configured to carry the capabilities of monitoring performance of LSP provided by the source node in the performance monitoring field of perfMonitor Object, and send to the destination node the capabilities of monitoring performance of LSP through a Path message carrying the perfMonitor Object; and
the destination node is configured to carry the capabilities of monitoring performance of LSP provided by the destination node in the performance monitoring field of perfMonitor Object, and send to the source node the capabilities of monitoring performance of LSP through a Resv message carrying the perfMonitor Object.

22. The system of claim 21, wherein:
the RSVP is further extended, an error code and an error value are added to an error code field and an error value field of an error description object, the error code and the error value indicate that the negotiation of protection manner fails; and
when the destination node does not provide the required capabilities of monitoring performance of LSP, the destination node is configured to send a PathErr message carrying the error description object to the source node to notify the source node that the negotiation of capabilities of monitoring performance of LSP fails.

23. The system of claim 19, wherein:
the LSP is established through the Label Distribute Protocol (LDP) or a Constraint Route LDP (CR-LDP), and the LDP or the CR-LDP is extended to have a perfMonitor type-length-value (TLV) carrying a performance monitoring field;
the source node is configured to carry the capabilities of monitoring performance of LSP provided by the source node in the performance monitoring field of perfMonitor TLV, and send to the destination node the capabilities of monitoring performance of LSP provided by the source node through a Label Request message carrying the perfMonitor TLV; and
the destination node is configured to carry the capabilities of monitoring performance of LSP provided by the destination node in the performance monitoring field of perfMonitor TLV, and send to the source node the capabilities of monitoring performance of LSP provided by the destination node through a Label Mapping message carrying the perfMonitor TLV.

24. The system of claim 23, wherein:
a state code field of the existing state TLV is extended, a state code indicating that a negotiation of protection manner fails is added to the state code field of the existing state TLV; and
when the destination node does not provide the required capabilities of monitoring performance of LSP, the destination node is configured to send a Notification message carrying the state TLV to notify the source node that the negotiation of capabilities of monitoring performance of LSP fails.
